(19) United States
(12) Patent Application Publication
(10) Pub. No.: US 2009/0064089 A1
(43) Pub. Date: Mar. 5, 2009

(54) System and Method for Autonomic Software Price Variation Via Application Virtualization and Streaming Technology

(75) Inventors: Joshua D. Lowry, Raleigh, NC (US); Khan M. Tasinga, San Jose, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,817

(22) Filed: Aug. 30, 2007

(51) Int. Cl. G06F 9/44

(52) U.S. Cl. 717/104

(57) ABSTRACT

The present invention provides a system and method for autonomic software price variation for virtualized applications of a computer program. The system includes a virtualization module that divides a software application into a plurality of discrete chunks an autonomic software price variation model that assigned a price to each of the plurality of discrete chunks, and a price update model that determines a number of downloads of each of the plurality of discrete chunks, wherein after a predetermined time period an updated price is computed for each of the plurality of discrete chunks. The present invention can also be viewed as a method that operates by dividing a software application into a plurality of discrete chunks, assigning a price to each of the plurality of discrete chunks, determining a number of downloads of each of the plurality of discrete chunks in a predetermined time period and computing an updated price for each of the plurality of discrete chunks.

### BACKGROUND OF THE INVENTION

1. Field of the Invention

This invention generally relates to methods and apparatus for software distribution and particularly to autonomic software price variation via application virtualization and streaming technology.

2. Description of Background

At a high-level, with respect to its distribution, software typically functions like any material good. A company produces a software product, sets its price, and makes it available for sale. The price of the software product is governed by the laws of economics and is thus, to some extent, tied to demand. Over time, if demand is high, the company behind the software product may raise its price to increase profit. Alternatively, if demand is low, the price of the software product may be reduced to spur its sale.

A company can optionally divide a software product into a set of logical components. Doing so enhances flexibility relative to distribution while potentially leading to an overall increase in revenue by the giving consumers the ability to only purchase what they need.

While a little limited, there is nothing intrinsically wrong with the current state of software distribution. What is now in place has worked for years and will continue to do so into the foreseeable future. However, software is not like the more tangible material goods people are generally familiar with. Their unique characteristic opens the door to more dynamic and flexible approaches to distribution and pricing.

### SUMMARY OF THE INVENTION

Embodiments of the present invention provide a system and method for autonomic software price variation for virtualized applications of a computer program. The system includes a virtualization module that divides a software application into a plurality of discrete chunks an autonomic software price variation model that assigned a price to each of the plurality of discrete chunks, and a price update model that determines a number of downloads of each of the plurality of discrete chunks, wherein after a predetermined time period an updated price is computed for each of the plurality of discrete chunks.

Embodiment of the present invention can also be viewed as providing methods for autonomic software price variation for virtualized applications of a computer program. In this regard, one embodiment of such a method, among others, can be broadly summarized by the following steps. The method operates by (1) dividing a software application into a plurality of discrete chunks, (2) assigning a price to each of the plurality of discrete chunks, (3) determining a number of downloads of each of the plurality of discrete chunks in a predetermined time period and (4) computing an updated price for each of the plurality of discrete chunks.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer utilizing the autonomic software price variation for virtualized applications system of the present invention.

FIG. 2 is a flow chart illustrating an example of the operation of the autonomic software price variation for virtualized applications system of the present invention, as shown in FIG. 1.

FIG. 3 is a flow chart illustrating an example of the operation of the price update for current application module on the computer that is utilized in the autonomic software price variation for virtualized applications system of the present invention, as shown FIGS. 1 and 2.

The detailed description explains the preferred embodiments of the invention, together with advantages and features, by way of example with reference to the drawings.

### DETAILED DESCRIPTION OF THE INVENTION

This invention disclosure presents a novel model and process for pricing software by leveraging application virtualization and streaming technology.

Application virtualization and streaming technology makes it possible to automatically divide an application into discrete chunks and distribute, on the fly (stream), the minimum set of chunks required to support its execution. Chunk distribution is managed in a centralized fashion. A central server hosts the application and handles request for its chunks.

Customers create accounts on the central server. Each chunk is assigned a base price. When a chunk is transmitted, the central server bills the account of the customer who submitted the request. Ownership of the chunk is granted and the customer caches it for future use. The following couple of advantages become apparent.

A company does not have to concern itself with dividing its software product into a set of logically marketable components. Application virtualization automatically divides the application into several discrete chunks. Not having to manually break a software product up into smaller pieces can save both time and money.

Customer flexibility is greatly enhanced. A customer only needs to pay for the chunks required to support application execution. Purchasing an entire product is only necessary if all of its functionality is exercised.

In addition to supporting the advantages presented above, managing chunk distribution in a centralized fashion opens the door to autonomic price variation. The central server tracks how many times each chunk has been obtained. That information provides a window into the demand for each piece of an application. The central server is equipped with a black box function that computes the price of a chunk based on the number of times it has been requested over a specified length of time (that is, f(interval length, download count)=price). It periodically applies the function to each chunk, varying their price. The price of each chunk is dynamic, automatically fluctuating in response to demand over time. Advantages are as follows.

After defining a base price for each chunk and an appropriate price function, f(interval length, download count), a company can put much less effort, if any, into managing the price of its software. Utilizing less time and resources for that work contributes to the bottom line.

A company can use the information maintained by the central server to focus its development effort. For example, if the company knows that chunk A is being downloaded more than chunk B, and consequently has a higher price, it can target updates for chunk A, with concrete knowledge of the fact that there is more money in doing so.

Any application virtualization tool can be used to virtualize the application in the first step. The pricing function presented in the second step is simple. A real company would likely develop a much more sophisticated and complex pricing functions.

The statistics database on the central server shown in the third step can be built with pretty much any technology, ranging from flat files, to structured XML documents, to relational databases. Chunks in the virtual application stream are transmitted over a network. The network can be based on a standard protocol, like TCP/IP, or a custom protocol specially designed for application chunk distribution. The Virtual Application Player is responsible for retrieving/caching chunks and application execution. It is made available as part of the application virtualizatior technology described above.

An example is as follows. Company X produces a software product Z. It runs an application virtualization tool to divide Z into distinct chunks. Each chunk is assigned a base price of Y dollars. Downloads numbers (D) of each discrete program chunk is tracked for a predetermined time period (T). After the predetermined time period expires, the price of each discrete program chunk is updated. This updated price (UP) is based on the number of downloads (D) tracked for a predetermined time period (T), that is multiplied by a price variation factor and then added to the base price (B) [i.e. UP=B+PVF (D)]. The price variation factor may be a constant or a price variation function.

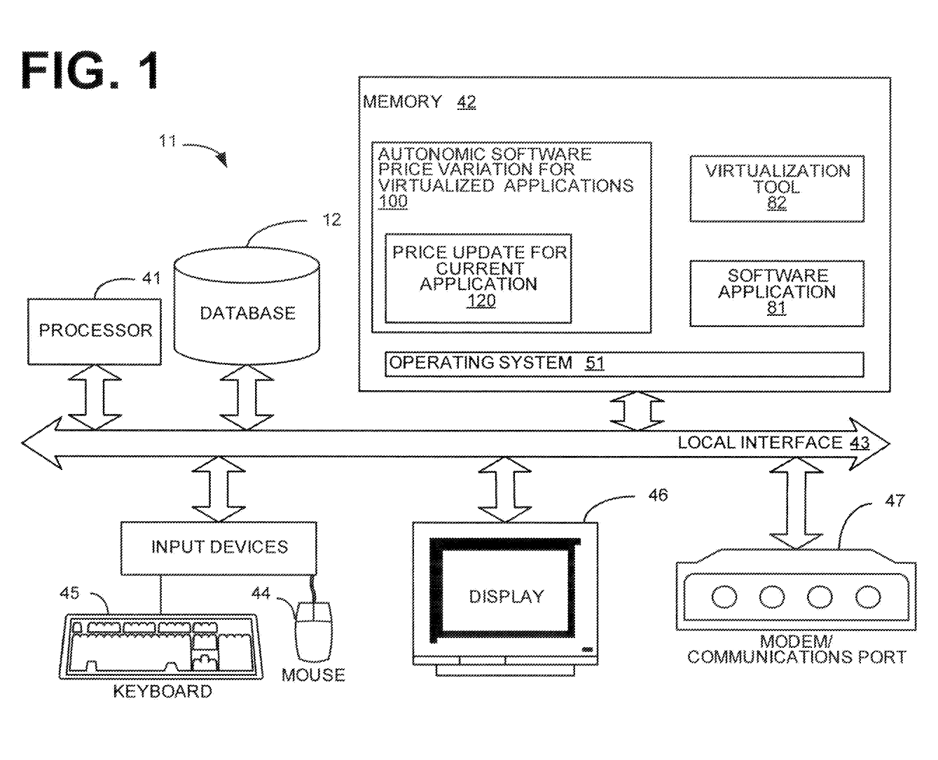

FIG. 1 is a block diagram illustrating an example of a computer II utilizing the Autonomic software price variation for virtualized applications system 100 of the present invention. Computer 11 includes, but is not limited to, PCs, workstations, laptops, PDAs, palm devices and the like. Generally, in terms of hardware architecture, as shown in FIG. 1, the computer 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the computer 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 1, the software in the memory 42 includes a suitable operating system (O/S) 51, software application 81 and virtualization tool 82, and the autonomic software price variation for virtualized applications system 100 of the present invention. As illustrated, the autonomic software price variation for virtualized applications system 100 of the present invention comprises numerous functional components including, but not limited to, the price update for current application module 120.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a Linux operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, and provides scheduling, input-output control, file and data management, memory management, and communication control and related services. It is contemplated by the inventors that the autonomic software price variation for virtualized applications system 100 of the present invention is applicable on all other commercially available operating systems.

The autonomic software price variation for virtualized applications system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the Autonomic software price variation for virtualized applications system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the computer 11 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the computer 11 is activated.

When the computer 11 is in operation, the processor 41 is configured to execute software stored within the memory 42, to communicate data to end from the memory 42, and to generally control operations of the computer 11 are pursuant to the software. The autonomic software price variation for virtualized applications system 100 and the O/S 51 are read, in whole or in part, by the processor 41, perhaps buffered within the processor 41, and then executed.

When the autonomic software price variation for virtualized applications system 100 is implemented in software, as is shown in FIG. 1, it should be noted that the autonomic software price variation for virtualized applications system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The autonomic software price variation for virtualized applications system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the autonomic software p ice variation for virtualized applications system 100 is implemented in hardware, the autonomic software price variation for virtualized applications system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

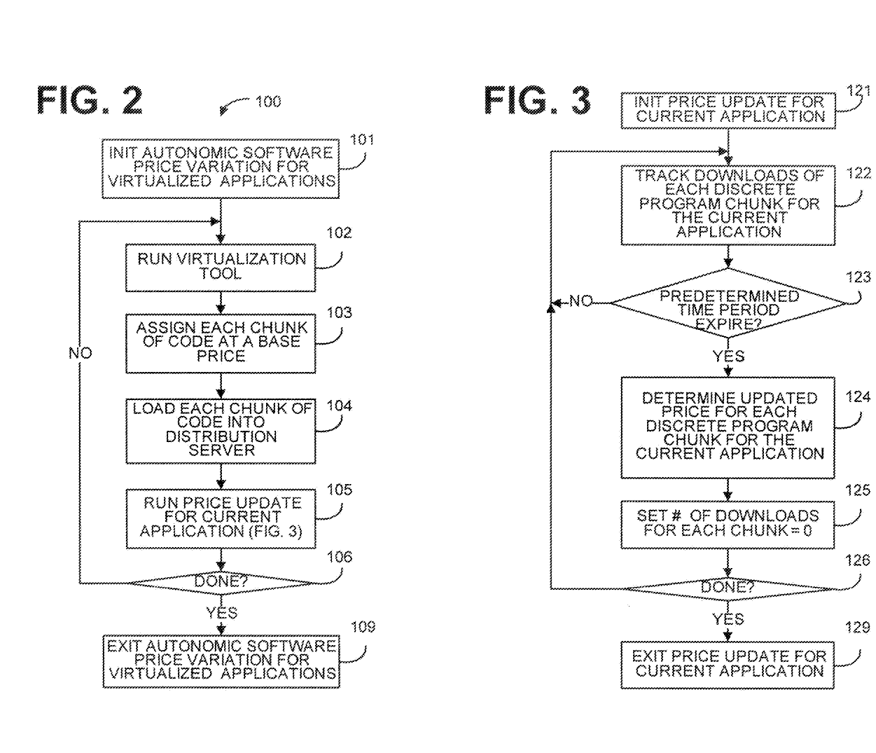

FIG. 2 is a flow chart illustrating an example of the operation of the autonomic software price variation for virtualized applications system 100 of the present invention, as shown in FIGS. 1 and 2. The autonomic software price variation for virtualized applications system 100 virtualizes a current application into discrete chunks, assigns each discrete chunk a base price and loads each discrete chunk into a distribution server for access.

First at step 101, the autonomic software price variation for virtualized applications system 100 is initialized. This initialization may include startup routines and processes embedded in the BIOS of the computer 11. The initialization also includes the establishment of data values for particular data structures utilized in the autonomic software price variation for virtualized applications system 100.

At step 102, the autonomic software price variation for virtualized applications system 100 runs a virtualization tool 82 on the current software application 81. The virtualization tool 82 breaks up the software application 81 into discrete software application chunks.

At step 103, each discrete chunk of the software application is assigned a base price. In the preferred embodiment, the base price of each discrete chunk is determined by the user of computer 11. In alternative embodiments, complex pricing functions can be utilized to determine the base price at each discrete chunk of the software application.

At step 104, each discrete chunk of the software application is loaded onto memory on a distribution server. This memory may be memory 42 (FIG. 1) or a database 12 (FIG. 1).

At step 105, the price update for current application module is executed. The price update for current application is herein defined in further detail with regard to FIG. 3. The price update for current application module tracks the number of downloads for each discrete chunk of the software application and updates the price for each discrete chunk after a predetermined time period.

At step 106, the autonomic software price variation for virtualized applications system 100 determines if there are more software applications to be virtualized. If it is determined at step 106 that there are more software applications to be virtualized, then the autonomic software price variation for virtualized applications system 100 returns to repeat steps 102 through 106. However, if it is determined at step 106 that there are no more software applications to be virtualized, then the autonomic software price variation for virtualized applications system 100 of the present invention then exits at step 109.

FIG. 4 is a flow chart illustrating an example of the operation of the price update for current application module 120 on the computer that is utilized in the autonomic software price variation for virtualized applications system of the present invention, as shown in FIGS. 1 and 2. The price update for current application module 120 tracks the number of downloads for each discrete chunk of the software application and updates the price for each discrete chunk after a predetermined time period.

First at step 121, the price update for current application module 120 is initialized. This initialization may include startup routines and processes embedded in the BIOS of the computer 11. The initialization also includes the establishment of data values for particular data structures utilized in the price update for current application module 120.

At step 122, the price update for current application module 120 tracks downloads of each discrete program chunk for the current application. Downloads numbers (D) of each discrete program chunk is tracked for a predetermined time period (T). In one embodiment, the download statistics that keep track of the downloads of each discrete chunk is stored in database 12. However, in another embodiment, memory 42 is utilized to store the download statistics.

At step 123, the price update for current application module 120 determines if the predetermined time period has expired. Predetermined time period may be set by the user of computer 11 or can be set automatically in the software application that is virtualized. If it is determined at step 123 that the predetermined time period has not expired, then price update for current application module 120 returns to repeat step 122.

However, if the predetermined time period has expired, then price update for current application module 120 determines the updated price for each discrete chunk for the current application. This updated price (UP) is based on the number of downloads (D) that is multiplied by a price variation factor (PVF), that is then added to the base price (B) [i.e. UP=B+PVF (D)]. This updated price is computed for each discrete chunk of the current application. The price variation factor may be a constant or a pricing function.

At step 125, the number of downloads for each discrete chunk is reset to zero. At step 126, the price update for current application module 120 then determines if it is to continue tracking the number of downloads of each discrete chunk for the current application. If it is determined that the tracking of downloads is to continue, then the price update for current application module 120 then returns to repeat steps 122 through 126. However, if it is determined at step 126 that continued tracking of downloads is not to occur, then the price update for the current application then exits at step 129.

In one example, the price is updated on a daily basis. However, price update granularity is dictated by the company applying this approach. If desirable, this model can be used to continuously update chunk prices in real-time (kind of like the stock market).

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A autonomic software price variation for virtualized applications system, the system comprising:
a virtualization module that divides a software application into a plurality of discrete chunks;
a autonomic software price variation model that assigned a price to each of the plurality of discrete chunks; and
a price update model that determines a number of downloads of each of the plurality of discrete chunks, wherein after a predetermined time period, a updated price is computed for each of the plurality of discrete chunks.

2. The system of claim 1, wherein the price update model computes the updated price of the plurality of discrete chunks is equal to the number of downloads over a predetermined amount of time that is then multiplied by a price variation factor.

3. The system of claim 2, wherein the price update model resets the number of downloads of each of the plurality of discrete chunks to zero after computing the updated price.

4. A method for autonomic software price variation for virtualized applications of a computer program, comprising:
dividing a software application into a plurality of discrete chunks;
assigning a price to each of the plurality of discrete chunks;
determining a number of downloads of each of the plurality of discrete chunks in a predetermined time period; and
computing an updated price for each of the plurality of discrete chunks.

5. The method of claim 4, wherein the computing an updated price further comprises:
determining the number of downloads in the predetermined time period:
multiplying by a price variation factor by the result; and
adding the result to the price.

6. The method of claim 5, wherein the computing an updated price further comprises:
resetting the number of downloads of each of the plurality of discrete chunks after computing the updated price.
